(19) United States
(12) Patent Application Publication
(10) Pub. No.: US 2002/0152837 A1
(43) Pub. Date: Oct. 24, 2002

(54) Pedal axis for children's vehicle

(76) Inventor: Joaquim Matias de Oliveira, Guarulhos (BR)

Correspondence Address: BIRCH STEWART KOLASCH & BIRCH, PO BOX 747, FALLS CHURCH, VA, 22040-0747, US

(21) Appl. No.: 09/839,563

(22) Filed: Apr. 23, 2001

(51) Int. Cl. G05G 1/14

(52) U.S. Cl. 74/594.4

(57) ABSTRACT

Pedal axle for child's vehicle that is formed by two identical and symmetrical halves, that has a part (1) intended to be inserted with a corresponding part (1) of the other axle half, this part is L-shaped and is joined in one piece to a disk-shaped part (3) with a circular cross-section that ends in a circular flange (4) also molded in one piece and an intermediary inclined part (5) projects from this flange, molded in one piece, whose other end (5′) is disk-shaped with a circular section and from which a cylindrical horizontal part projects (6) that ends in an elastic grip (7) in the free end of the axle half and that is intended to be inserted in the opening (8) of the respective pedal.

The present invention refers to an axle for supporting the pedals of a child's vehicle such as, for example, a tricycle.

Normally, the pedals of a tricycle or a similar child's vehicle, are joined at a metal axle that goes through an opening in the front wheel of the vehicle. This metal axle is generally cylindrical and requires costly casting or forging operations to obtain the proper form for providing movement in the vehicle wheel through the action of the pedals.

This invention aims at providing an axle that is molded in strong plastic that can advantageously replace the metal axle.

The plastic axle of the present invention is a component in two symmetrical halves, one for each pedal, and both separate parts are symmetrical with respect to the other. Each axle half has a grip in one end of a cylindrical portion, this grip is intended to be inserted inside an opening of the pedal, this cylindrical portion is linked in a single piece by means of intermediary parts to a part parallel to the cylindrical part and located at a different height intended to be inserted with a corresponding part of the symmetrical axle half. The symmetry of the two axle halves in accordance with the invention is necessary in order for one pedal to be in an up position while the other is in a down position to enable the pedaling of the child's vehicle.

The present invention can be better evaluated in view of the attached drawings wherein:

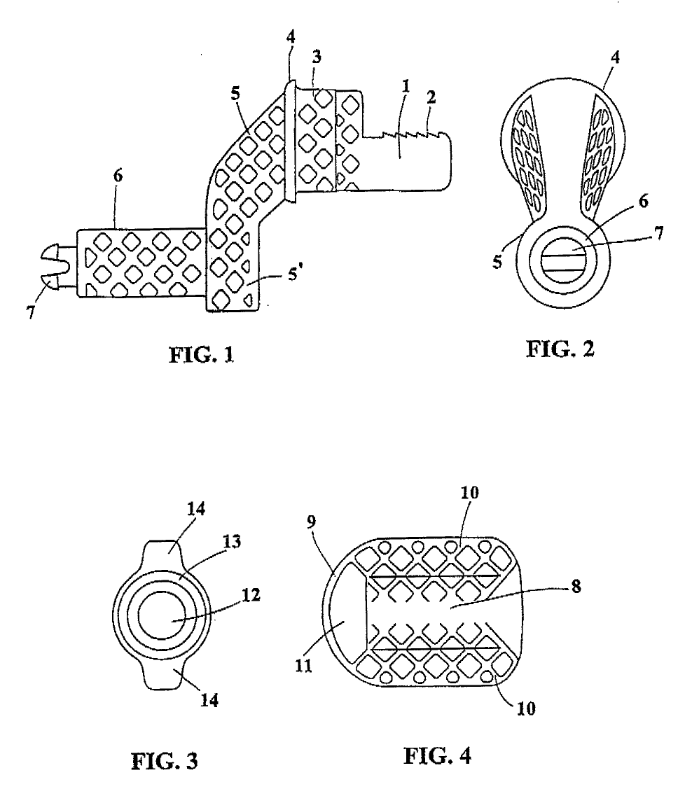

FIG. 1 is a lateral view of one of the pedal halves in accordance with the present invention, it being understood that the other half has the position symmetrically opposed to that represented in this figure during use.

FIG. 2 is a view of the pedal axle half taken from the end to be inserted in the pedal.

FIG. 3 is a view of the pedal taken from the end within the same.

FIG. 4 is a lateral view of a pedal intended to receive an axle half in accordance with the present invention.

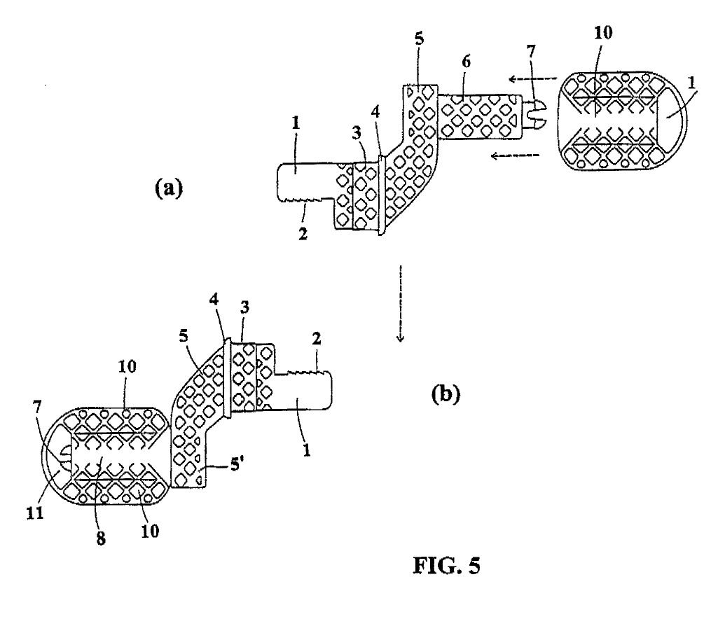

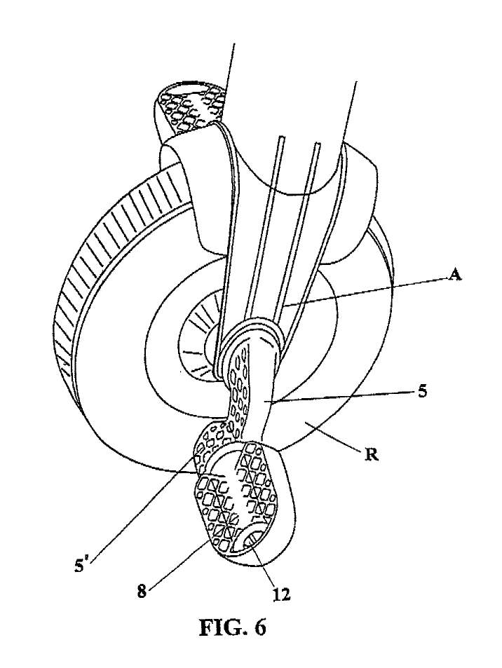

FIG. 5 represents the assembly phases of an axle half in the respective pedal, each phase a) and b) is illustrated for each pedal so as to be able to visualize the insertion of the two axle halves.

FIG. 6 represents a perspective view of the assembled unit in a front wheel of a child's vehicle.

In accordance with that seen in the drawings, the pedal axle of the present invention is a component in two symmetrical parts, of which only one is illustrated in FIGS. 1 and 2.

This axle half is a piece that has a part 1 intended to be inserted into a corresponding part 1 of the other axle half, this part is L-shaped and has grooves 2 in its surface in contact with the other half. This part is joined in one piece to a disk-shaped part 3 with a circular cross-section that ends in a circular flange 4 also molded in one piece. An intermediary inclined part 5 projects from the flange which is also molded in one piece and whose other end part 5′ is disk-shaped. A horizontal cylindrical part 6 projects from the end of part 5 and terminates in an elastic grip 7 at the free end of the axle half and that is intended to be inserted in the opening of the pedal.

FIGS. 3 and 4 illustrate a pedal that is to be joined to an axle half in accordance with the present invention. The more or less U-shaped pedal is molded in a single piece and poured with a cylindrical central part horizontally arranged 8 with a smaller diameter opening 12 toward the exterior and a larger diameter opening 13 for the insertion of the cylindrical part of the axle half. The peripheral U-shaped portion 9 of the pedal is connected to this cylindrical part 8 by means of reinforcement parts 10 on one side and on the other by the cylindrical part, with a cavity 11 between the outside end of the cylindrical part [and] the curved part of the U that constitutes the shape of the pedal.

FIG. 5 illustrates the joining phases of the pedal axle halves in the respective pedal, phase (a) showing an axle half still separated from the pedal, and the phase (b) showing the other axle half already inserted in the pedal, it being understood that the grooves 2 in the respective parts 1 of each axle half fit into each other in the vehicle wheel opening. Moreover, the grip 7 fits tightly in the opening 12 of the cylindrical part 8 of the pedal.

FIG. 6 lastly illustrates the unit mounted in the fork A of a wheel R of a child's vehicle such as a tricycle.

The use of a pedal axle in plastic will provide a number of benefits, including:

a) the possibility of using various colors in the manufacturing process, which makes the vehicle aesthetically more attractive.

b) increased durability of the vehicle which will endure less wear in the axle, after frequently use in sun and rain; a metal axle in this case would undergo the action of corrosion (rust);

c) a reduction in production phases and the assembly process.

1. Pedal axle for child's vehicle that is formed by two identical and symmetrical halves, characterized by the fact that it has a part (1) intended to be inserted with a corresponding part (1) of the other axle half, this part is L-shaped and is joined in one piece to a disk-shaped part (3) with a circular section that terminates in a circular flange (4) also molded in one piece; an intermediary inclined part (5) projects from this flange and is also molded in one piece and whose other end (5′) is disk-shaped and has a circular cross-section from which a horizontal cylindrical part (6) projects and which ends in an elastic grip (7) in the free end of the axle half and that is intended to be inserted in the opening (8) of the respective pedal.

2. Pedal axle in accordance with claim 1, wherein the part (1) of an axle half includes grooves (2) in the surface in contact with the part (1) of the other half that also includes corresponding grooves (2).

3. Pedal axle in accordance with claims 1 and 2, wherein the cylindrical part (6) fits inside an open cylindrical part (8) in the pedal so that the grip 7 fits tightly inside this part (8).
